(19) United States
(12) Patent Application Publication
(10) Pub. No.: US 2002/0124612 A1
(43) Pub. Date: Sep. 12, 2002

(54) Slide bolt lock

(75) Inventor: Walter Evans, Richmond, KY (US)

Correspondence Address: ARENT FOX KINTNER PLOTKIN & KAHN, PLLC, Suite 600, 1050 Connecticut Avenue, N.W., Washington, DC, 20036-5339, US

(73) Assignee: Mas-Hamilton Group, Inc.

(21) Appl. No.: 09/800,783

(22) Filed: Mar. 8, 2001

(51) Int. Cl. E05B 55/04

(52) U.S. Cl. 70/469

(57) ABSTRACT

A lock, particularly well suited for use with a safe which includes a movable door latch mechanism having a lock bolt abutment surface. The lock has a casing having a bolt-receiving aperture in one of its walls. The casing is to be mounted to the door, for example, on the inside surface of the door with the bolt-receiving aperture adjacent the bolt-abutment surface of the door latch mechanism. A bolt is slidably mounted in the casing for movement at an angle relative to the bolt abutment surface of the door latch mechanism between a locked position projecting through the aperture in the casing and into abutment with the abutment surface of the door latch mechanism and an unlocked position out of abutment with the abutment surface of the door latch mechanism and retracted into the casing.

### BACKGROUND OF THE INVENTION

1. Field of the Invention

The present invention relates to locks, and more particularly to locks for security containers and the like having a movable bolt for engagement with a door latch mechanism that locks the container, and for disengagement from the door latch mechanism to permit unlocking the container.

2. Description of the Related Art

SlideBolt™ type locks are, per se, known. FIGS. 1 and 2 illustrate two prior art locks. FIG. 1 provides one view of the lock disclosed in U.S. Pat. No. 5,588,318 and FIG. 2 illustrates a lock currently manufactured by the Mas-Hamilton Group.

U.S. Pat. No. 5,588,318 issued to Shelby M. Osbome on Dec. 31, 1996 shows a lock 10 for a safe door. The lock 10 shown in FIG. 1 includes a bolt 33 slidably mounted in case 14 of the lock 10 for movement into and out of a bolt-receiving opening 30. The bolt 33 moves at an angle with respect to an adjacent door latch mechanism, when installed, and into the bolt-receiving opening in that mechanism to lock the door and out of the bolt-receiving opening to unlock the door. The bolt 33 is moved to the retracted unlocked position by the coaction between the door latch mechanism and bolt 33. Therefore, lock 10 does not require internal actuators to move the lock bolt 33 to the retracted unlocked position. The abutment face 34 of the bolt 33 is perpendicular to the front-end wall 20 of the housing 28.

This lock may function when the angle φ is between 40 and 50 degrees and the abutment face 34 perpendicular to front end wall 20 as disclosed, however, when the angle φ is larger than 50 degrees and the abutment face 34 perpendicular to front end wall 20, the bolt 33 cannot easily be retracted into the case 14 utilizing the door latch mechanism.

FIG. 2 illustrates a second lock 10′ having a bolt 33′ with a roller 69′ located at one end of bolt 33′. The employment of roller 69′ permitted the angle +to be larger than 50 degrees. Unfortunately, the bolt 33′ with roller 69′ is more expensive to manufacture and requires closer installation tolerances. Consequently, while the roller 69′ permits a larger range of angles φ the lock and installation labor has a higher end cost.

Therefore, there is a need for a low cost, easy to install lock that has a bolt that can be retracted by the door latch mechanism (bolt works). Additionally, there is a need for a bolt whose length may be lengthened without opening the lock case, thus allowing larger installation tolerances.

### SUMMARY OF THE INVENTION

The present invention solves the problems discussed above and illustrates a bolt whose length may be easily adjusted without opening the case. The invention also provides a bolt that may be installed in a lock case at a greater range of angles and where the abutment face is not perpendicular to the front-end wall.

The present invention provides a lock with a bolt, that is moved to the retracted unlocked position by the coaction between a door latch mechanism and the bolt. Therefore, this lock does not require internal actuators to move the lock bolt to the retracted unlocked position.

The present invention provides a lock, particularly well suited for safes and the like for selectively engaging a bolt abutment surface of a door latch mechanism to lock the door. The lock has a casing to be attached adjacent the door latch mechanism. The casing has a bolt-receiving aperture with the bolt slidably mounted within the casing for movement relative to the bolt abutment surface of the door latch mechanism. The bolt moves between a locked position where one end of the bolt projects into abutting relationship with the bolt-abutment surface of the door latch mechanism to prevent movement of the door latch mechanism, and an unlocked position retracted out of abutting relationship with the bolt-abutment surface of the door latch mechanism.

### BRIEF DESCRIPTION OF THE DRAWINGS

The accompanying drawings incorporate in and forming part of the specification illustrate several aspects of the present invention, and together with the description serve to explain the principles of the invention. In the drawings:

FIG. 1 is an internal cross-section of the prior art lock disclosed in U.S. Pat. No. 5,588,318.

FIG. 2 is an internal cross-section of a prior art lock Manufactured by Mas-Hamilton Group.

FIG. 3 is an internal cross-section of one embodiment of a lock of the present invention with a bolt in the retracted or unlocking position.

FIG. 4 is an internal cross-section of one embodiment of a lock of the present invention with a bolt in the extended or locking position.

FIG. 5 is a side view of a removable wear plate that may be installed in a lock illustrated in FIGS. 3 and 4.

FIG. 6 is a side view of a removable wear plate with an extension that may be installed in a lock illustrated in FIGS. 3 and 4 to form the lock illustrated in FIGS. 7 and 8.

FIG. 7 is an internal cross-section of a second embodiment of a lock of the present invention with a bolt in the retracted or unlocking position.

FIG. 8 is an internal cross-section of a second embodiment of a lock of the present invention with a bolt in the extended or locking position.

FIG. 9 is a schematic of one typical installation of the lock of the present invention in a safe.

FIG. 10 is a schematic of another typical installation of the lock of the present invention in a safe.

Reference will now be made now in detail to the present embodiment of the invention, an example of which is illustrated in the accompanying drawings.

### DETAILED DESCRIPTION OF THE PREFERRED EMBODIMENT

With reference to FIGS. 3-4 and 7-10, there is shown a lock, generally denoted as the numeral 100, particularly well suited for use with a safe 60 or other security container or vault.

With reference to FIGS. 3-4 and 7-8, the lock 100 typically includes a generally rectangular case 114. Case 114 maybe formed from: a first side wall (not shown), a second side wall 118 parallel to and spaced from the first side wall, a front end wall 120 perpendicular to and extending between the first and second side walls, a back wall 122 spaced from and parallel to the front end wall 120 extending between the first and second side walls, a top wall 124 mutually perpendicular to the side walls and end walls 120, 122, and a bottom wall 126 spaced from and parallel to the top wall. As shown, the end walls 120 and 122 may be integral with the top wall 124, bottom wall 126, and second sidewall 118, which mutually cooperate to define a housing 128. The first side wall may be removably secured to the housing 128 by removable fasteners such as bolts.

The front-end wall 120 is formed with a bolt-receiving aperture 130 that may be laterally centered between the first sidewall and the second sidewall 118. Therefore, the lock device 100 can be symmetrical about a vertical centerline so that the same lock 100 can be utilized in an installation as both a right-hand and left-hand lock. The housing 128 is formed with a bolt-receiving channel 132 in open communication at one end with the bolt-receiving aperture 130. The channel 132 has a longitudinal axis 131 that extends from the bolt-receiving aperture 132 at an angle +to the front-end wall 120 into the interior of the housing 28. The angle φ may range from about 20 degrees to about 90 degrees. The current prototype employs an angle φ that is about 57 degrees.

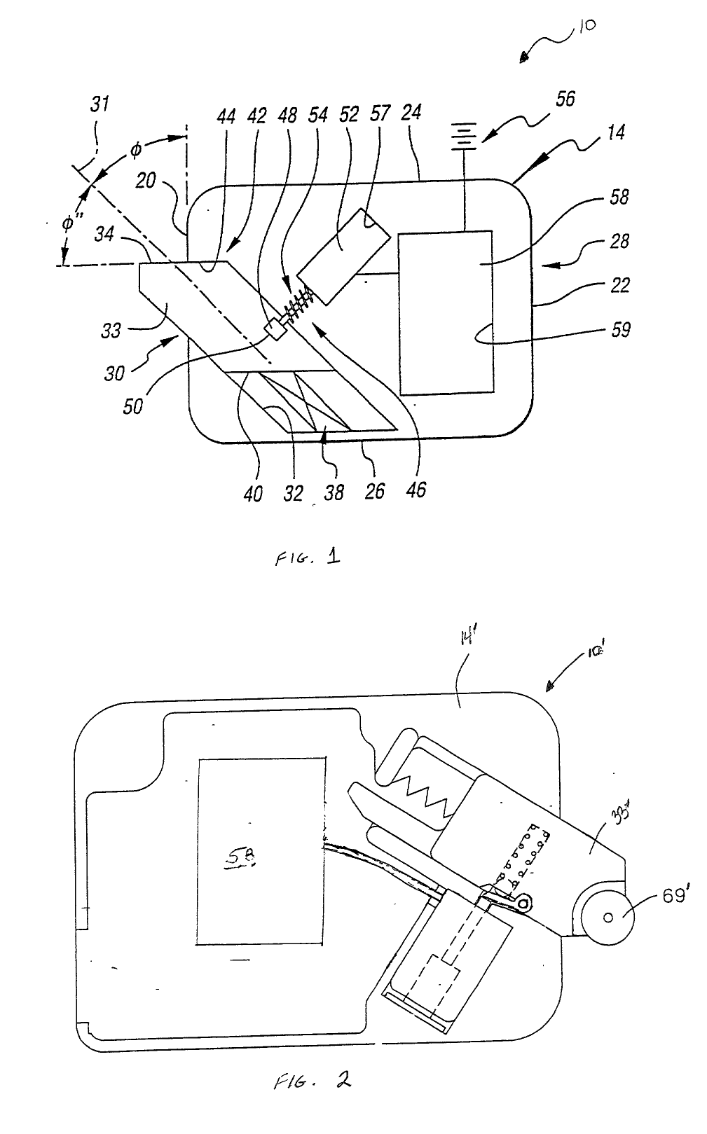

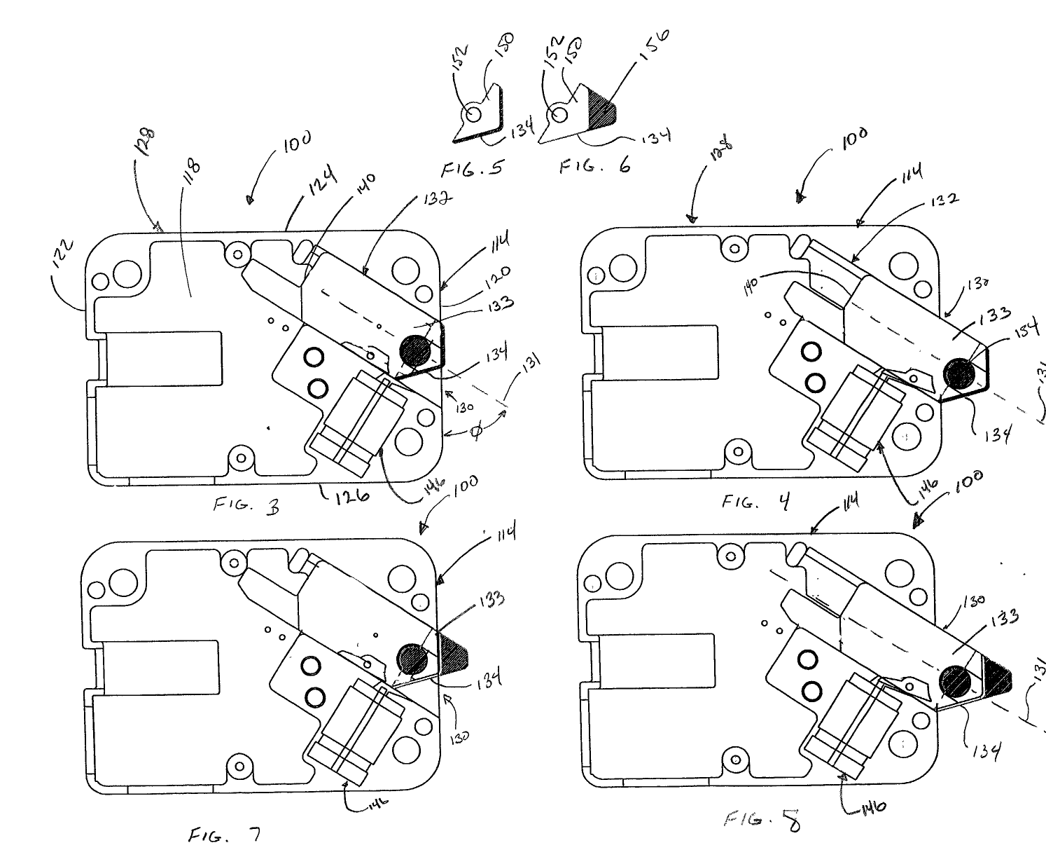

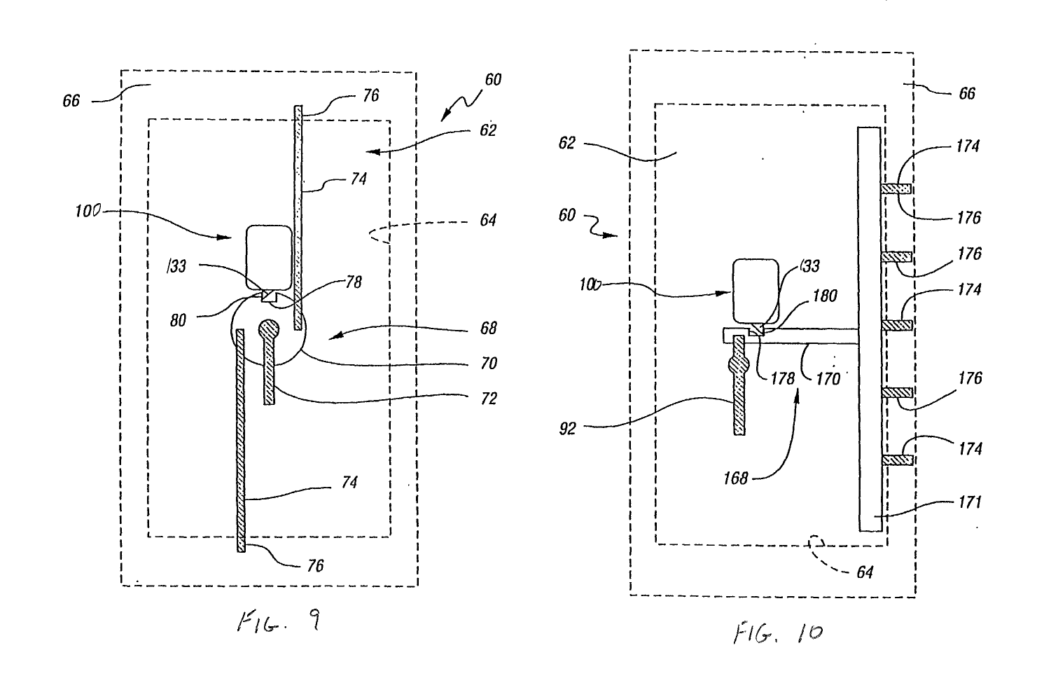

An elongated lock bolt 133 is located in the elongated channel 132 with the longitudinal axis of the bolt 133 coincidental with the longitudinal axis 131 of the bolt-receiving channel 132. Bolt 133 slides in channel 132 between a locking position (see FIGS. 4 and 8) where one end of the bolt 133 projects outwardly through the aperture 130, and an unlocking position (see FIGS. 3 and 7) where the bolt 133 is retracted. The end of the lock bolt 133 adjacent the bolt-receiving aperture 130 in the front end wall 120 has a working or abutment face 134 which is at an angle a relative to the longitudinal axis 131. The angle a of the abutment face 134 relative to the longitudinal axis 131 is preferably in the range of about 40 degrees to about 50 degrees. Therefore, the abutment face 134 relative of the bolt 33 is not approximately perpendicular to the front end wall 120 of the housing 128, unless the angle φ is approximately equal to the angle α.

The bolt 133 may be biased to slide in the channel 132 toward bolt-receiving aperture 130 in the housing front end wall 120 to outwardly project the working or abutment end 134 projects the housing 128 through the bolt-receiving aperture 130. A resilient biasing means (not shown), such as, for example, a spring may be located between the housing and the end 140 of the bolt opposite the end having abutment face 134.

The housing 128 may be formed with a first bolt stop which cooperates with the bolt 133 to limit the sliding movement of the bolt 133 (due to the force generated by the biasing means) outwardly of the housing 128 through the bolt-receiving aperture 130 so that the abutment face 134 of the bolt 133 protrudes from the aperture 130 a predetermined distance. Bolt stops retain a bolt within a lock case are well known in the art, thus a detailed description is not required.

With continued reference to FIGS. 3, 4, 7, and 8, the lock 100 also includes second stop 146 to selectively prevent movement of the bolt 133 inwardly into the housing 128 from the locking or projecting position (see FIGS. 4 and 8) to the unlocking or retracted position (see FIGS. 3 and 7). The second stop 146 and the appropriate control circuits may be selected from those known in the art of electronic locks.

Bolt 133 may be formed such that a replaceable wear plate 150 may be installed. This wear plate 150 may take the shape of the bolt as shown in FIGS. 3-5. Alternatively, wear plat 150 may have an extension 156 as illustrated in FIGS. 6-8 provided wear plate 150 and extension 156 have sufficient strength, extension 156 may serve as a bolt extension. Thus, the length bolt of 133 could be easily adjusted without cutting and/or machining bolt 133 or replacing bolt 133. Wear plate 150 may be manufactured from any wear resistant material. When wear plate 150 has an extension 156 that serves as a bolt extension then wear plate 150 must have sufficient strength to provide the required level of security.

Wear plate 150 may be carried on bolt 133 by retaining pin 154. Pin 154 may be pass through bolt 133 and opening 152 in wear plate 150. Alternatively, wear plate 150 may be joined to bolt 133 by an interference fit, welding, bonding or any other method whereby the bolt 133 and wear plate 150 move and act reliably as a single unit and where wear plate 150 may be replaced if required by wear or other circumstances.

Now with reference to FIG. 9, there is shown one known type of safe 60 of conventional design (shown in phantom lines) which includes a door 62 for closing the opening 64 in the safe body or box 66. The safe 60 includes a bolt works or door-latching mechanism, generally denoted as the numeral 68. The typical bolt works 68 includes a lock bolt engagement mechanism such as a latch cam 70 located inside the safe door 62 and connected to a handle 72 located on the exterior side of the door 62. The bolt works 68 also includes a plurality of door-latching rods 74 also located inside the safe door 62 for movement into and out of rod-receiving cavities 76 formed in the jamb of the door opening 64 adjacent the distal ends of the door-latching rods 74. The proximal ends of each door-latching rod 74 inside the door are pivotably connected to the latch cam 70 so that as the handle 72 is rotated the cam 70 is rotated moving the latching rods 74 either into or out of the rod-receiving cavities 76 depending upon the direction of rotation of the handle 72 and, therefore, the direction of rotation of the latch cam 70. The lock bolt engagement mechanism or latch cam 70 has a lock bolt-receiving notch 78 with a lock-bolt abutment surface 80. The lock 100 of the present invention is shown as being installed in a right-hand orientation positioned adjacent the lock bolt-engagement mechanism 70 with the bolt-receiving aperture 130 in the front end wall 120 in facing alignment with the lock bolt-receiving notch 78 when the bolt works 68 is in the door latch position with the door-latching rods 74 received in the rod-receiving cavities 76 thereby latching the door 62. With the bolt works 68 in this latched position, the lock bolt 133 is positioned in the locking position (see FIGS. 4 and 7) under the influence of the biasing force of a spring or other means for extending the bolt 133. With the bolt 133 projecting through the bolt-receiving aperture 130 of the lock 100 into the lock bolt-receiving notch 78 of the lock bolt-engagement mechanism 70 with the abutment face 134 of the bolt 133 abutting the lock-bolt abutment surface 80. If a person attempts to turn the handle 72 to move the bolt works 68 from the door latch position without first activating the lock 100, the abutting relationship of the lock bolt-abutment surface 80 of the bolt-receiving notch 78 in the lock bolt-engagement mechanism 70 abutting the abutment face 134 of the lock bolt 133 prevents movement of the bolt works 68 so that the door-latching rods 74 cannot be removed or retracted from the rod-receiving cavities 76. The lock bolt 133 cannot move in the channel 132 from the locking position (see FIGS. 4 and 7) to the unlocking position (see FIGS. 3 and 6) because the second stop 146 prevents retracting bolt 133. In order to move the bolt works 68 from the door latched position to a door unlatched position the door-latching rods 74 are removed from the rod-receiving cavities 76, the lock device 100 must be activated to clear the second stop 146. This is accomplished by, for example, inputting a correct code into a coded electrical signal device, which then energizes a solenoid. The action of the energized solenoid frees the lock bolt 133 for sliding movement in the channel 132 against the biasing force of the spring. Then, when the bolt works 68 is moved by the handle 72 from the door latched position to the door unlatched position, the bolt lock abutment surface 80 of the bolt-receiving notch 78 in the lock bolt engagement mechanism 70 is forced or pushes against the abutment face 134 of the lock bolt 133. The bolt abutment face 134 functions in the manner of a cam surface providing a force component longitudinally of the lock bolt 133 pushing or forcing the lock bolt 133 into the reacted position (see FIGS. 3 and 7) and out of contact with the bolt lock abutment surface 80 of the bolt-receiving notch 78 thereby allowing the latch cam 70 of the bolt works 68 to move from door latched position to the door unlatched position pulling the door latching rods 74 out of the rod-receiving cavities 76 unlatching the safe door 62.

Now with reference to FIG. 10, there is shown another type of known safe 60 of conventional design (shown in phantom lines) which includes a door 62 for closing the opening 64 in the safe body or box 66. The safe 60 includes a bolt works or door-latching mechanism, generally denoted as the numeral 168. The bolt works 168 includes a lock bolt engagement mechanism such as a horizontal bar 170 located inside the safe door 62 and pivotally connected at one end to a handle 72 located on the exterior side of the door 62 and with a vertical bar 171 attached to the other end of the horizontal bar 170. A plurality of door-latching rods 174 are attached at spaced intervals to the vertical bar 171 for movement into and out of rod-receiving cavities 176 formed in the jamb of the door opening 64 adjacent the distal ends of the door-latching rods 174. As the handle 72 is rotated the horizontal bar 170 moves longitudinally moving the vertical bar 171, and the latching rods 174 either into or out of the rod-receiving cavities 176 depending upon the direction of rotation of the handle 72 and, therefore, the direction of movement of the horizontal bar 170. The lock bolt engagement mechanism or horizontal 170 has a lock bolt-receiving notch 178 with a lock-bolt abutment surface 180. The lock device 10 of the present invention is shown as being installed in a left-hand orientation positioned adjacent the lock bolt-engagement mechanism 170 with the bolt-receiving aperture 30 in the front end wall 20 in facing alignment with the lock bolt-receiving notch 178 when the bolt works 168 is in the door latch position with the door-latching rods 174 received in the rod-receiving cavities 176 thereby latching the door 62. With the bolt works 168 in this latched position, the lock bolt 133 is positioned in the locking position (see FIGS. 4 and 8) under the influence of the biasing force with bolt 133 projecting through the bolt-receiving aperture 130 of the lock device 100 into the lock bolt-receiving notch 178 of the lock bolt-engagement mechanism 170 with the abutment face 134 of the bolt 133 abutting the lock bolt abutment surface 180. If a person attempts to turn the handle 72 to move the bolt works 168 from the door latch position without first activating the lock device 100 the lock bolt-abutment surface 180 of the bolt-receiving notch 178 in the lock bolt-engagement mechanism 170 abutting the abutment face 134 of the lock bolt 133 prevents movement of the bolt works 168 so that the door-latching rods 174 cannot be removed or retracted from the rod-receiving cavities 176. The lock bolt 133 cannot move in the channel 132 from the locking position (see FIGS. 4 and 8) to the unlocking position (see FIGS. 3 and 7) because second stop 146 is positioned to prevent retracting lock bolt 133. In order to move the bolt works 168 from the door latched position to a door unlatched position whereat the door-latching rods 174 are removed from the rod-receiving cavities 176, the lock device 100 must be activated to move second stop 146. This is accomplished by, for example, inputting a correct code into a electrical signal output device 158 which then energizes a solenoid. The energized solenoid 152 pushes the stop 148 out of the stop receiving notch 150 which frees the lock bolt 133 for sliding movement in the channel 132 against the biasing force of the spring. Then, when the bolt works 168 is moved by the handle 72 from the door latched position to the door unlatched position, the bolt lock abutment surface 180 of the bolt-receiving notch 178 in the lock bolt engagement mechanism 170 is forced or pushed against the abutment face 134 of the lock bolt 133. The bolt abutment face 134 functions in the manner of a cam surface providing a force component longitudinally of the lock bolt 133 pushing or forcing the lock bolt 133 into the housing 128 to the retracted position (see FIGS. 3 and 7) against the biasing force of the spring and out of contact with the bolt lock abutment surface 180 of the bolt-receiving notch 178 thereby allowing the horizontal bar 170 of the bolt works 168 to move from door latched position to the door unlatched position pulling the door latching rods 174 out of the rod-receiving cavities 176 unlatching the safe door 62.

It can be readily seen from the above discussions regarding the safe 60 of FIGS. 9 and 10 that the lock device 100 of the present invention provides a bolt 133 orientation and configuration which allows self-activated from the projecting or locking position of FIGS. 4 and 8 to the retracted or unlocking position of FIGS. 3 and 7, that is, bolt 133 is moved from the locking position to the unlocking position by coaction with a door latch mechanism. Therefore, the lock device 100 does not require internal actuators or mechanisms to move the bolt between the locking and unlocking positions.

Also, shown in FIGS. 9 and 10, it is clear that, due to the symmetry of the bolt-receiving aperture 130, the same lock device 100 of the present invention can be used for both left-hand and right-hand installations.

The foregoing detailed description is given primarily for clearness of understanding and no unnecessary limitations are to be understood therefrom for modifications will become obvious to those skilled in the art upon reading this disclosure and may be made without departing from the spirit of the invention and scope of the appended claims.

I claim:

1. A lock for selectively locking and unlocking a door, the lock comprising:
a casing having a bolt receiving channel with a bolt receiving aperture slidably receiving the bolt in the channel the casing configured for attachment to a door with a bolt-receiving aperture facing the door latch mechanism;
a lock bolt having a projecting end with an abutment face at the projecting end thereof at an angle of about 40 degrees to 50 degrees to the longitudinal axis of the lock bolt;
the lock bolt slidably mounted within the casing for movement at an acute angle relative to the bolt abutment surface of the door latch mechanism between a locking position where the projecting end of the lock bolt projects through the bolt-receiving aperture and into abutting relationship with the bolt abutment surface of the door latch mechanism, and an unlocking position where the lock bolt is retracted, the lock bolt being responsive to abutment by the lock bolt abutment surface of the door latch mechanism to retract into the casing.

2. A lock device for selectively locking and unlocking a door, the lock comprising:
a casing comprising a first side wall a second side wall parallel to and spaced from the first side wall, a front end wall perpendicular to and extending between the first and second side walls and a bolt-receiving aperture is formed in the front end wall substantially laterally centered between the first and second side walls, the casing to be attached to a door with the bolt-receiving aperture facing the bolt abutment surface of the door latch mechanism; and,
the elongated lock bolt slidably mounted within the casing for movement at an acute angle relative to the bolt abutment surface of the door latch mechanism between a locking position whereat the lock bolt has a projecting end which projects through the bolt-receiving aperture and into abutting relationship with the bolt abutment surface of the door latch mechanism, and an unlocking position whereat the lock bolt is retracted into the casing, the lock bolt being responsive to abutment by the lock bolt abutment surface of the door latch mechanism to retract into the casing.

3. The lock of claim 1 wherein the casing comprises:
a first side wall;
a second side wall parallel to and spaced from the first side wall;
a front end wall extending between the first and second side walls; and,
the bolt-receiving aperture is formed in the front end wall substantially laterally centered between the first and second side walls.

4. The lock of claim 3, further comprising:
means defining a lock bolt-receiving channel in the casing in open communication at one end with the bolt-receiving aperture of the casing front end wall slidably receiving the lock bolt, the longitudinal axis of the bolt-receiving channel extending into the casing from the bolt-receiving aperture at an acute angle to the front end wall; and,
the lock bolt comprises an abutment face at the projecting end thereof adjacent the bolt-receiving aperture, the abutment surface being disposed at an acute angle to the longitudinal axis of the channel substantially equal to the acute angle of the longitudinal axis of the channel relative to the casing front wall.
